(19) United States
(12) Patent Application Publication
(10) Pub. No.: US 2024/0330058 A1
(43) Pub. Date: Oct. 3, 2024

(54) METHOD AND SYSTEM FACILITATING CONFIGURABLE STATE PROCESSING IN BLOCKCHAIN SYSTEMS

(71) Applicant: JIO PLATFORMS LIMITED, Ahmedabad, Gujarat (IN)

(72) Inventors: Dilip KRISHNASWAMY, Bangalore, Karnataka (IN); Aayush BHATNAGAR, Navi Mumbai, Maharashtra (IN)

(21) Appl. No.: 18/292,971

(22) PCT Filed: Jul. 28, 2022
(86) PCT No.: PCT/IB2022/056989

§ 371 Date: Jan. 29, 2024

(30) Foreign Application Priority Data
Jul. 29, 2021 (IN) 202121034200

(51) Int. Cl. G06F 9/50

(52) U.S. Cl. CPC G06F 9/5027

(57) ABSTRACT

The present invention provides a method and system for facilitating configurable state processing in blockchain systems. The system may be configured to receive a set of data packets corresponding to state variables in any or a combination of incremental transitions and end to end transaction from an initial E2E-BState to an end E2E-BState. from a first computing device, extract a first set of attributes from the set of data packets received corresponding to one or more paths in a state transition graph starting from the initial E2E-BState to the end E2E-BState. With the help of the ML engine, the system may trace a predefined path based that may be secure and any or a combination of the incremental transitions and the end-to-end state transitions may be configurable and then capture, record or store changes to the state variables in a database.

### FIELD OF INVENTION

The embodiments of the present disclosure generally relates to state variable processing, and more particularly to techniques for implementing configurable state transitions and microservices in vLDT/blockchain platforms.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In the present scenario, typical blockchain applications involve a sequence of state transitions to be accomplish the overall goal of the blockchain end to end transaction. To accomplish the sequence of state transactions, a blockchain end to end transaction (E2E-BTransaction) is realized as a sequence of incremental blockchain transactions (Inc-BTransactions). The state transition graph for a blockchain use-case can have forks and merges, so that different E2E-BTransactions can take different paths to completion. The paths can end in transaction failure or success. Typical Blockchain platforms (such as Hyperledger Fabric) support a concept of shared state where the state is concurrently updated by all participating peers.

The need for concurrent state processing and updates by each of the peers is needed when all the peers do not trust each other, and hence need to perform concurrent execution of smart contract(s) and then independently determine and record the state value in memory/storage at their respective nodes. However, the level of trust can vary depending on a particular use-case. In other use-cases, the peers in the blockchain entity may trust the neutral blockchain platform to execute one or more smart contract(s) to determine the state value after execution. In some use-cases, the peers on the blockchain may trust a single peer to determine the state value. In such scenarios, the need for concurrent execution and coordination of state across peers needs to be eliminated to help with faster processing in the blockchain system

Thus, there is a need for a blockchain system that provides configurability in the design for processing of state for blockchain transactions.

### OBJECTS OF THE PRESENT DISCLOSURE

Some of the objects of the present disclosure, which at least one embodiment herein satisfies are as listed herein below.

It is an object of the present disclosure to provide a system and a method to facilitate support for configurable internal versus external state management relative to a vDLT/Blockchain platform with support for determining both incremental states and end-2-end states utilizing configurable internal versus external smart contract microservices to process information.

It is an object of the present disclosure to provide a method that facilitates flexibility in operation based on the needs of any variation such that the state processing can be configured appropriately for a plurality of variations with respect to the end-to-end and incremental state variables.

It is an object of the present disclosure to provide a system and a method that enables different vDLT/Blockchain use-cases to be processed.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a state management system for facilitating configurability in blockchain based transactions. The system may include one or more processors coupled to one or more computing devices in a network. The one or more processors may be further coupled with a memory that may store instructions which when executed by the one or more processors may cause the one or more processors to receive a set of data packets from a first computing device, the set of data packets may include one or more transactions in any or a combination of one or more incremental blockchain transitions and one or more end to end blockchain transaction from an initial end to end blockchain state (E2E-BState) to an end end-to-end blockchain state (E2E-BState), the one or more transactions pertaining to one or more state variables. The one or more processors may then extract a first set of attributes from the set of data packets received, the first set of attributes corresponding to one or more paths in a state transition graph starting from the initial end to end blockchain state to the end end-to-end blockchain state and then trace, by a machine learning (ML) engine operatively coupled to the one or more processors, a predefined path based on the first set of attributes extracted, such that the predefined path may be secure and any or a combination of the incremental blockchain transitions and the end-to-end blockchain state transitions may be configurable. The one or more processors may further capture, one or more changes to the state variables obtained after tracing each state transition in the any or a combination of incremental transitions and end to end transaction from the initial E2E-BState to the end E2E-BState in a database, and then determine an outcome associated with the one or more changes to the state variables for each state transition in the any or a combination of incremental transitions and end to end transaction from the initial E2E-BState to the end E2E-BState.

In an embodiment, the state variables may pertain to one or more parameters of a transaction.

In an embodiment, an information about a state can be a combination of both a current value of each state variable, and an incremental state transition if each state variable underwent a transition during a state transition.

In an embodiment, a plurality of options is provided to store the information about the state that is either internal or external to the system, the plurality of options including at least four variations such as External-Internal (ExtInt), Internal-internal (IntInt), External-external (ExtExt), and Internal-External (IntExt) for end-to-end state and incremental state transition management. Thus, the system provides support for configurable internal versus external state management relative to a vDLT/Blockchain platform with support for determining both incremental states and end-to-end states utilizing configurable internal versus external smart contract microservices to process information.

In an embodiment, in the ExtInt variation, the end-to-end state may be managed external to the system, and the incremental state transitions may be managed internal to the system.

In an embodiment, in the IntInt variation both the end-2-end state and the incremental state transitions may be managed internal to the system.

In an embodiment, in the ExtExt variation both the end-2-end state and the incremental state transitions are managed external to the system.

In an embodiment, in the IntExt variation, the end-to-end state may be managed internal to system, and the incremental state transitions are managed external to the system.

In an embodiment, the one more processor may further cause the system to manage, the one or more state variables external to the system in a stateless manner, centrally distribute, the one or more state variables are state variables in the system, equally distribute the one or more state variables among the one or more computing devices associated with the system, store, by the one or state variables in a single computing device and manage, the one or more state variables in one or more computing devices (peers).

In an embodiment, the one or more processor may further cause the system to manage, the variations based on a level of pre-determined trust in the one or more computing devices associated with the system.

In an embodiment, the one more processor may further cause the system to transition, a state variable from a centralized management module to a concurrently distributed management module associated with the one or more processors and vice versa, manage the state transfers ownership of a state variable to another computing device; and transfer the ownership of a state variable up and down a hierarchical chain of computing devices.

In an embodiment, the one or more processor may cause the system to orchestrate an end-to-end processing of one or more incremental tasks associated with the one or more transactions.

In an embodiment, the one or more processors may orchestrate an end-to-end processing of one or more incremental tasks associated with the one or more transactions. Thus, the system provides flexibility in operation based on the needs of any variation such that the state processing can be configured appropriately for a plurality of variations with respect to the end-to-end and incremental state variables.

In an aspect, the present disclosure provides for a method for facilitating configurability in blockchain based transactions. The method may include the step of receiving, by one or more processors, a set of data packets from a first computing device, the set of data packets comprising one or more transactions in any or a combination of one or more incremental blockchain transitions and one or more end to end blockchain transaction from an initial end to end blockchain state to an end end-to-end blockchain state, and the one or more transactions pertaining to one or more state variables. In an embodiment, the one or more processors may be coupled to one or more computing devices in a network, the one or more processors may be further coupled with a memory. The method may further include the step of extracting, by the one or more processors, a first set of attributes from the set of data packets received, the first set of attributes corresponding to one or more paths in a state transition graph starting from the initial end to end blockchain state to the end end-to-end blockchain state. The method may also include the step of tracing, by a machine learning (ML) engine operatively coupled to the one or more processors, a predefined path based on the first set of attributes extracted, such that the predefined path may be secure and any or a combination of the incremental blockchain transitions and the end-to-end blockchain state transitions may be configurable. The method may further include the step of capturing, by the one or more processors, one or more changes to the state variables obtained after tracing each state transition in the any or a combination of incremental transitions and end to end transaction from the initial E2E-BState to the end E2E-BState in a database. Furthermore, The method may further include the step of determining, by the one or more processors, an outcome associated with the one or more changes to the state variables for each state transition in the any or a combination of incremental transitions and end to end transaction from the initial E2E-BState to the end E2E-BState.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which the system of the present disclosure can be implemented, in accordance with an embodiment of the present disclosure.

FIG. 2 illustrates an exemplary representation (200) of system (110), in accordance with an embodiment of the present disclosure.

FIG. 3 illustrates exemplary method flow diagram (300) depicting a method for processing of state for blockchain transactions based on a machine learning based architecture, in accordance with an embodiment of the present disclosure.

FIGS. 4A-4D illustrate exemplary block diagrams of the functional blocks associated with at least four variations of state management, in accordance with an embodiment of the present disclosure.

FIG. 5 illustrates an exemplary block diagram (500) of the functional blocks of a Hierarchical Internal Internal (IntInt) State Management, in accordance with an embodiment of the present disclosure.

FIG. 6 illustrates an exemplary representation of an example of IntInt state management, in accordance with an embodiment of the present disclosure.

FIGS. 7-8 illustrate exemplary representations of Hierarchical State Management, in accordance with an embodiment of the present disclosure

FIG. 9 illustrates an exemplary computer system in which or with which embodiments of the present invention can be utilized in accordance with embodiments of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The term “state variable, σᵢεS ∀i” referred herein is one of the set of variables that are used to describe the mathematical “state” of a dynamical system. Intuitively, the state of a system describes enough about the system to determine its future behaviour in the absence of any external forces affecting the system. At any given step during a blockchain processing, each state variable σᵢεS ∀i can change its value.

Each microservice can either be stateless or stateful. A system that uses microservices typically has a stateless web and/or mobile application that uses stateless and/or stateful services. Stateless microservices do not maintain any state within the services across calls. They take in a request, process it, and send a response back without persisting any state information. A stateful microservice persists state in some form in order for it to function.

The present invention provides a robust and effective solution to an entity or an organization with the help of a system and method that provides a production grade blockchain platform that can deliver high performance for blockchain applications, with adequate flexibility to support the needs for different use-cases. To utilize the platform effectively, the design of state management for a blockchain application on the blockchain platform may be done based on awareness of the design constraints for the use-cases, and a state management can be done based on one or more proposed methods.

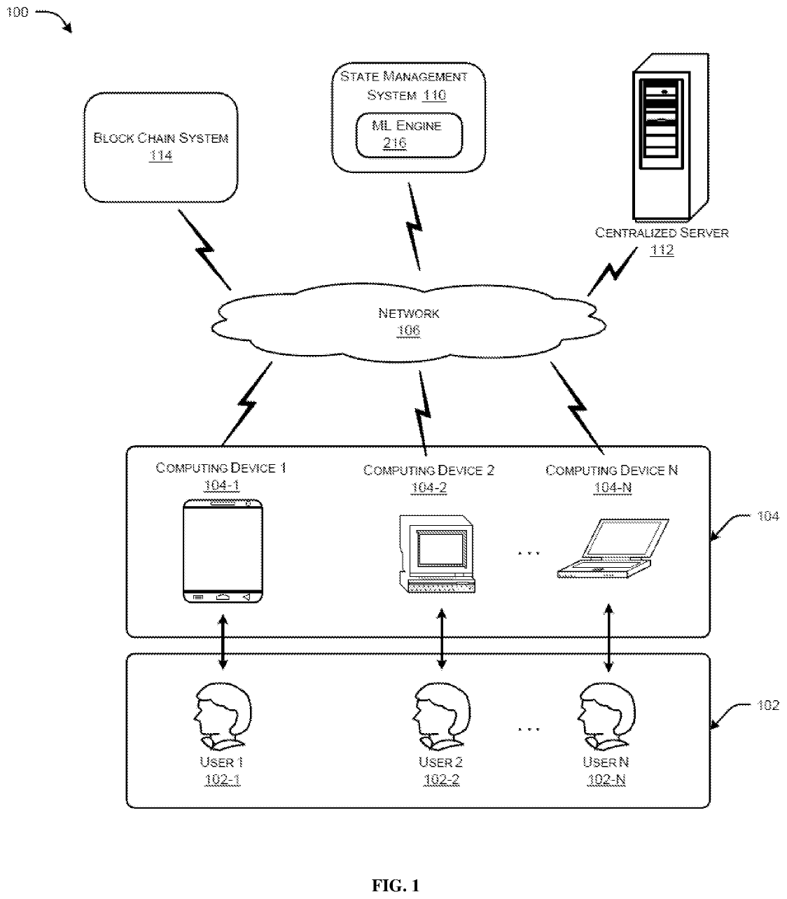

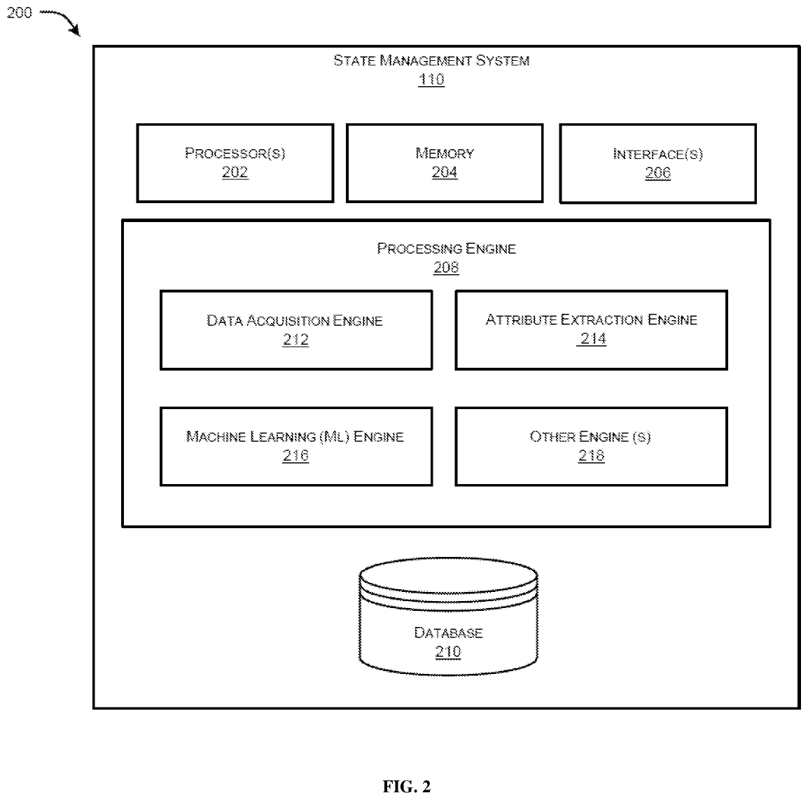

FIG. 1 illustrates an exemplary network architecture in which or with which the system of the present disclosure can be implemented, in accordance with an embodiment of the present disclosure. As illustrated, in an aspect, a blockchain system (114) that may be associated with a plurality of computing devices (104-1, 104-2 . . . 104-N) (collectively referred to as computing devices (104) and individually as computing device (104)) through a network (106). The computing devices (104) may be associated with one or more users (102). In a way of example and not as a limitation, the computing devices (104) may be further communicatively coupled to at least a centralized server (112) through the network (106). More specifically, the exemplary architecture (100) includes a state management system (110) or simply as system (110) hereinafter) equipped with a machine learning (ML) engine (216) (described later with reference to FIG. 2) for facilitating processing of state for blockchain transactions.

The state management system (110) may be configured to receive a set of data packets from a first computing device (104-1). The set of data packets may include state variables in any or a combination of incremental blockchain transitions (also referred to as “inc-BTstate” hereinafter) and end to end transaction from an initial end to end blockchain state (also referred to as “E2E-BState” hereinafter) to an end E2E-BState. The state management system (110) may further extract a first set of attributes from the set of data packets received. The first set of attributes correspond to one or more paths in a state transition graph starting from the initial E2E-BState to the end E2E-BState. With the help of the ML engine (216), the state management system (110) may trace a predefined path-based on the first set of attributes extracted, such that the predefined path may be secure and any or a combination of the incremental transitions and the end-to-end state transitions may be configurable. The state management system (110) may capture and store changes to the state variables for each state transition in the any or a combination of incremental transitions and end to end transaction from the initial E2E-BState to the end E2E-BState in a database. The state management system (110) may further record an outcome associated with the changes to the state variables for each state transition in the any or a combination of incremental transitions and end to end transaction from the initial E2E-BState to the end E2E-BState in the database.

For example, for some simple use-cases, the E2E-BTransState may have just one begin state (start), and one end state (success or failure), with no intermediate states in between. However, most blockchain applications go through a progression of states at the application layer before the end-to-end (E2E) blockchain application task is completed. The end-2-end state and the incremental state transitions can be managed in different ways depending on the needs of a use-case. Smart contracts can be configured to be executed external or internal to a blockchain platform to effect these state changes.

In another example, considering a supply chain. Suppose, in the supply chain, goods have to be shipped from Pune to Singapore. There are different people involved in shipping the goods from Pune to Singapore and the routes of transport can be from Pune to Mumbai to Singapore, or Mumbai to Chennai to Singapore and the like. For an end-to-end blockchain state, the system just needs to know about the initial and the final destinations, i.e., Mumbai and Singapore respectively. This can be the upper block chain. However, the upper block chain includes a plurality of lower block chains. The lower block chains are incremental in nature and include minute details about the transport of goods, who are the people involved in the supply, transport and delivery of the goods and the like. The upper blockchain may further contain the tracking status of the goods, i.e, where the goods have reached at a particular point of time. The system can maintain a local ledger for road transport, another ledger for ship transport and maintain an end-to-end blockchain comprising of lower block chains connected to the upper block chains. Herein, the states can be the amount of goods shipped, the value of the goods, time when the goods left a particular location, who is transporting the goods and the like.

Other such examples where the system (110) can be applicable are in smart contracts, tracking smart meter readings for various purposes, user token management, managing home/office or mobile IoT-based security, managing financial transactions, tracking Industrial IoT Oil Pilferage and many more.

Thus, if A, B, C are the state in a block chain system, one can go from A to B to C and so on. But to go from A to B, one can also go from A1, A2, A3 . . . to B. Herein, A can be the initial state and C can be the end state. A1, A2, A3 . . . and B1, B2, B3 . . . can be the incremental states. In an exemplary embodiment, the system (110) can provide support to all incremental states as well as the initial and the end state. The system (110) can store, quantize and share the incremental and the initial, end to end states across the block chain system and there is no limit to the number of incremental states.

In an exemplary embodiment, information about a state can be a combination of both a current value of each state variable (E2E state value), and an incremental state transition if each state variable underwent a transition during a state transition.

In an exemplary embodiment, the state management system (110) may provide a plurality of options to store the information about the state that may be either internal to the vDLT/blockchain system or external to the vDLT/blockchain system. As a way of example and not as a limitation, there may be at least four variations such as External-Internal (ExtInt), Internal-internal (IntInt), External-external (ExtExt), and Internal-External (IntExt) but not limited to the like for end-to-end state and incremental state transition management. In ExtInt variation, the end-to-end state may be managed external to the blockchain platform, and the incremental state transitions may be managed internal to the blockchain platform. In IntInt variation, both end-2-end state and incremental state transitions may be managed internal to the blockchain platform. In the Variation ExtExt bothend-2-end state and incremental state transitions may be managed external to the blockchain platform. In the Variation IntExt, the end-to-end state is managed internal to the blockchain platform, and the incremental state transitions are managed external to the blockchain platform.

In an embodiment, the state variables can be centralized, or concurrently distributed and shared across all computing devices (104) (interchangeably referred to as peers hereinafter), or stored at a single peer, or managed by a subset of peers, or managed external to the blockchain system in a stateless manner, and the like. Hence a state management can be of different types such as Stateless State Management, Central State Management, Concurrent State Management, Peer State Management, Peer Subset State Management or a combination thereof.

The state management system (110) coupled to the blockchain system (114)/vDLT may be configured to provide support for such variations as needed by a specific use-case. Depending on the level of trust in the use-case, one or more of these different variants of managing state variables may be utilized. In an exemplary embodiment, additional variations may include a Hybrid State Management, where a state variable could transition from a computing device that is centralized Trusted to a computing device that is concurrently Distributed and vice versa; a Transferable State Management where the peer that manages the state can transfer ownership of a state variable to another peer; and a Hierarchical State Management where the ownership of the state can be transferred up and down a hierarchical processing system tree.

In an embodiment, execution of the method for the blockchain system processes through a plurality of states of processing end-to-end, from the initial E2E-BState to the end E2E-BState which involves different state transitions to make the progress. An end-state can be reached by one or more paths in the BAppState state transition graph starting from an initial state.

In an exemplary embodiment, a transaction can involve different tasks such as smart contract execution, processing endorsements, policy validation, and transaction recording but not limited to the like. The outcome of such processing can be recorded in a database that may include a vDLT/Blockchain Ledger, and the corresponding changes to state variables can be captured for each state transition.

In an exemplary embodiment, if the vDLT/Blockchain system may deal with incremental tasks, the state management system (110) may be configured with a workflow management module to orchestrate the end-to-end processing of the incremental tasks through different state transitions in the blockchain system (114) to complete the end-to-end processing for the overall task. The incremental task can involve a sequence of incremental blockchain transactions.

In an exemplary embodiment, state management in the Blockchain system may be performed in such a way such that the state management system (110) may process transactions purely based on an input data provided in the transactions.

In an exemplary embodiment, the system (110) may support at least two types of state but not limited to it such as Blockchain E2E Application State (referred as E2E-BTransState hereinafter) and corresponds to S(θ) discussed earlier and Blockchain Incremental State (referred as Inc-BState hereinafter) and corresponds to πⱼ (θ) discussed earlier)

In an embodiment, the computing device (104) and/or the blockchain system (114) may communicate with the state management system (110) via set of executable instructions residing on any operating system, including but not limited to, Android™, iOS™, Kai OS™ and the like. In an embodiment, computing device (104) and/or the blockchain system (114) may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the computing device (104) and/or the blockchain system (114) may not be restricted to the mentioned devices and various other devices may be used. A smart computing device may be one of the appropriate systems for storing data and other private/sensitive information.

In an exemplary embodiment, a network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the state management system (110) may include one or more processors coupled with a memory, wherein the memory may store instructions which when executed by the one or more processors may cause the system to process state for blockchain transactions. FIG. 2 with reference to FIG. 1, illustrates an exemplary representation of state management system (110) for facilitating processing of state for blockchain transactions based on a machine learning based architecture, in accordance with an embodiment of the present disclosure. In an aspect, the state management system (110) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the state management system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the state management system (110 may include an interface(s) 206. The interface(s) 206 may comprise a variety of interfaces, for example, interfaces for data input and output devices, referred to as I/O devices, storage devices, and the like. The interface(s) 206 may facilitate communication of the state management system (110). The interface(s) 206 may also provide a communication pathway for one or more components of the state management system (110)). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the state management system (110) may comprise the machine-readable storage medium storing the instructions and the processing resource to execute the instructions, or the machine-readable storage medium may be separate but accessible to the state management system (110) and the processing resource. In other examples, the processing engine(s) (208) may be implemented by electronic circuitry.

The processing engine (208) may include one or more engines selected from any of a data acquisition (212), an attribute extraction engine (214), a machine learning (ML) engine (216), and other engines (218). The other engines (218) may include any of a Stateless State Management module, a Central State Management module, a Concurrent State Management module, a Peer State Management module, a Peer Subset State Management module, or a combination thereof, a Hybrid State Management module, a Transferable State Management module, and a Hierarchical State Management module, a signal processing engine, digital twin model generation engine, a prediction engine and the like.

In an embodiment, the data acquisition engine (212) of the state management system (110) can receive/process/pre-process a set of data packets from a first computing device (104-1). The set of data packets may include state variables in any or a combination of incremental transitions and end to end transaction from an initial E2E-BState to an end E2E-BState.

In an embodiment, the attribute extraction engine (212) of the state management system (110) may extract a first set of attributes from the set of data packets received. The first set of attributes correspond to one or more paths in a state transition graph starting from the initial E2E-BState to the end E2E-BState.

In an embodiment, the ML engine (212) of the state management system (110) may trace a predefined path based on the first set of attributes extracted, such that the predefined path may be secure and any or a combination of the incremental transitions and the end to end state transitions may be configurable. The ML engine (216) may capture and store changes to the state variables for each state transition in the any or a combination of incremental transitions and end to end transaction from the initial E2E-BState to the end E2E-BState in a database. The ML engine (216) may further record an outcome associated with the changes to the state variables for each state transition in the any or a combination of incremental transitions and end to end transaction from the initial E2E-BState to the end E2E-BState in the database.

In an exemplary embodiment, the state of an E2E-BTransaction θ is represented by a set S(θ) of state variables σ_{θ} (i)εS(θ), where each state variable σ_{θ} (i) is represented as a (key, value) pair which is stored in a state database in the system.
θ is a unique identifier for an E2E-BTransaction in the blockchain/vDLT system. The key represents a state variable name, and the value represents the current value of the state variable σ_{θ} (i) in the state transition graph path that is taken by an E2E-BTransaction. The number of state variables for the E2E-BTransaction θ is given by the cardinality |S(θ)| of the set S(θ). Each state variable σ_{θ} (i) can vary as a function of time during the processing of the E2E-BTransaction θ in the state transition graph for the blockchain use-case
Each E2E-BTransaction θ can undergo a sequence of state transitions πⱼ (θ) where jε[1,2,3, . . . K(θ)], where K(θ)] is the number of state transitions undertaken in the state transition graph path that is taken by θ.
The incremental processing completed during a state transition πⱼ (θ) in the state transition graph can include changes to one or more state variables in the set S(θ), along with the information about the incremental processing completed by the blockchain platform during that state transition. The incremental state transitions πⱼ (θ) are recorded in a blockchain ledger.

The state transition can be recorded as the event σ_{θ,j-1} (i)→σ_{θ,j} (i) for the subset of states i that were modified during the state transition transaction processing at time t. To record this, both the previous state of a state variable σ_{θ,j-1} (i) and the new state of the state variable σ_{θ,j} (i) are recorded to capture the information about the state transition πⱼ (θ). In addition, the inputs provided to enable the state transition, and any additional information such as digitally signed endorsements by stakeholders are also included to represent the state transition.

For the states that did not change during the state transition, σ_{θ,j} (i)=σ_{θ,j-1} (i). When the blockchain ledger is queried, all the past incremental state transitions πⱼ (θ) associated with θ can be retrieved. The current values of each of the state variables σ_{θ,i} (t) can be obtained by querying the corresponding state database where the state variables are stored.

For some simple use-cases, the E2E-BTransState may have just one begin state (start), and one end state (success or failure), with no intermediate states in between. However, most blockchain applications go through a progression of states at the application layer before the end-to-end (E2E) blockchain application task is completed. The end-2-end state and the incremental state transitions can be managed in different ways depending on the needs of a use-case. Smart contracts can be configured to executed external or internal to a blockchain platform to affect these state changes.

In an embodiment, the Stateless State Management module may be configured to manage the one or more state variables external to the system (110) in a stateless manner. In another embodiment, the centralized management module may centrally distribute the one or more state variables in the system (110).

In an embodiment, the Concurrent State Management module may be configured to distribute the one or more state variables among the one or more computing devices associated with the system. In another embodiment, the Peer State Management module may be configured to store the one or more state variables in a single computing device. In yet another embodiment, the Peer Subset State Management module may be configured to manage the one or more state variables by one or more computing devices (peers).

In an embodiment, the Hybrid State Management module may be configured to transition a state variable from the centralized management module to the concurrently distributed management module and vice versa. In another embodiment, the Transferable State Management module may be configured to manage the state transfer ownership of a state variable from one computing device to another computing device. In yet another embodiment, the Hierarchical State Management module may be configured to transfer the ownership of a state variable up and down a hierarchical chain of computing devices. In another embodiment, the workflow management module may be configured to orchestrate an end-to-end processing of one or more incremental tasks associated with the one or more transactions.

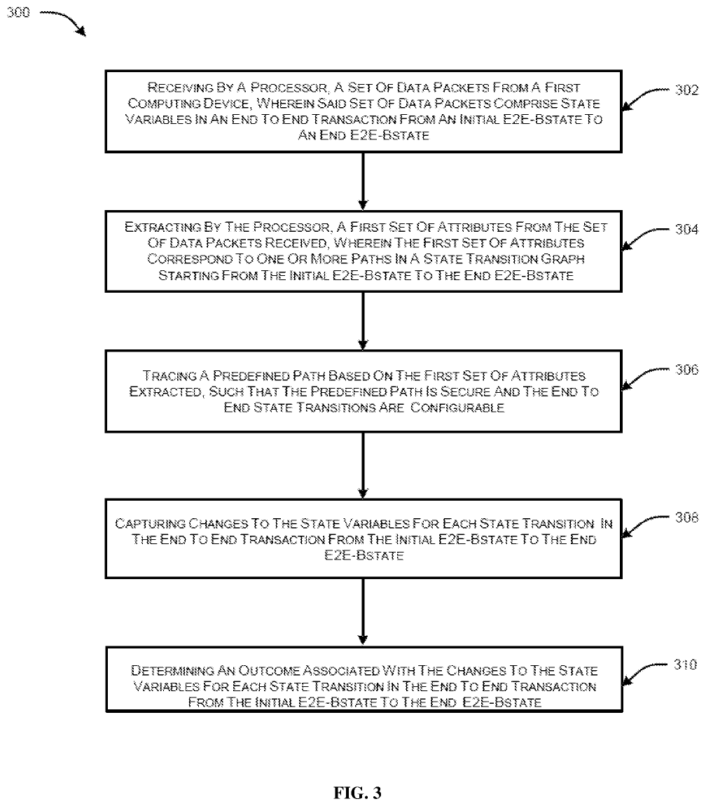

FIG. 3 illustrates an exemplary method flow diagram (300) depicting a method for processing of state for blockchain transactions based on a machine learning based architecture, in accordance with an embodiment of the present disclosure. As illustrated, in an aspect the method may facilitate processing of state for blockchain transactions based on a machine learning based architecture.

The method may include at 302, the step for receiving by a processor, a set of data packets from a first computing device (104-1). The set of data packets may include one or more state variables in any or a combination of incremental transitions and end to end transaction from an initial E2E-BState to an end E2E-BState.

The method may include at 304, the step for extracting by the processor, a first set of attributes from the set of data packets received. The first set of attributes correspond to one or more paths in a state transition graph starting from the initial E2E-BState to the end E2E-BState and at 306, the step for tracing a predefined path based on the first set of attributes extracted, such that the predefined path may be secure and any or a combination of the incremental transitions and the end to end state transitions may be configurable. Based on the extracted first set of attributes, the method (300) may include at 308 the step for capturing and storing changes to the state variables for each state transition in the any or a combination of incremental transitions and end to end transaction from the initial E2E-BState to the end E2E-BState in a database and at 310, the step for determining an outcome associated with the changes to the state variables for each state transition in the any or a combination of incremental transitions and end to end transaction from the initial E2E-BState to the end E2E-BState.

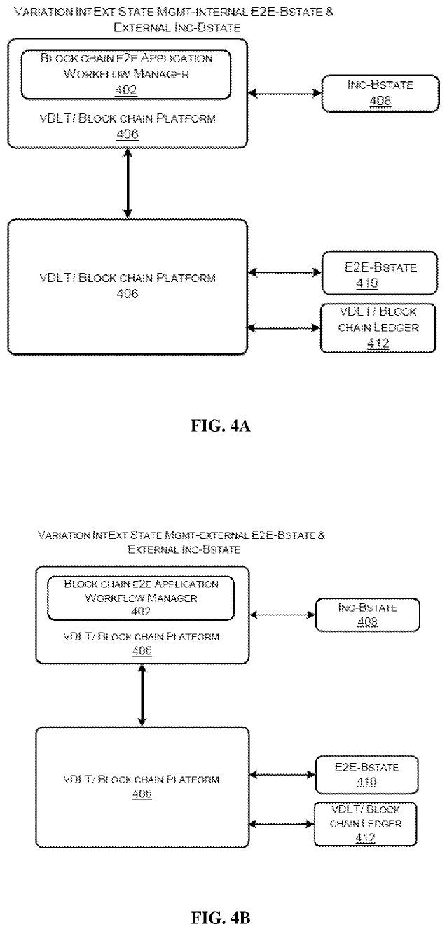

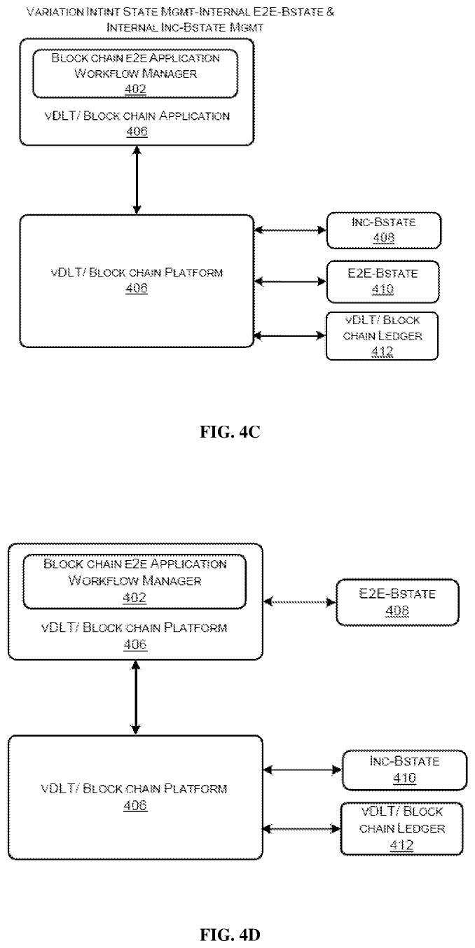

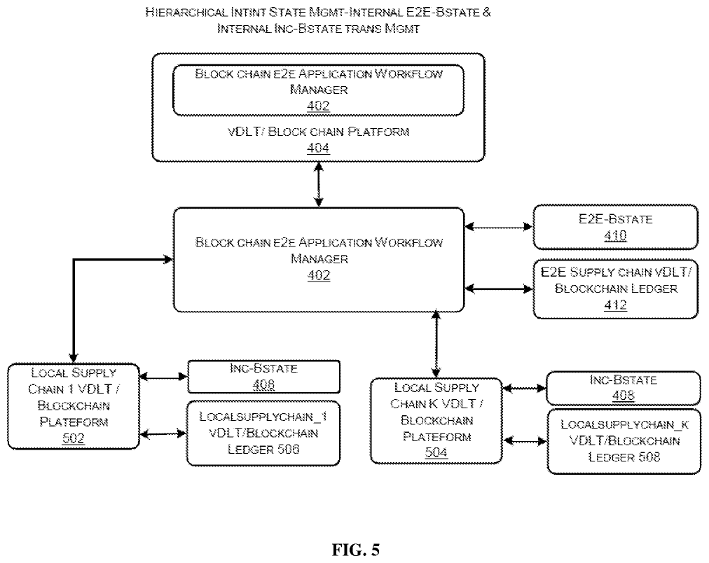

FIGS. 4A-4D illustrate exemplary block diagrams of the functional blocks associated with at least four variations of state management, in accordance with an embodiment of the present disclosure. As illustrated in FIG. 4A, in an aspect, an IntExt variation of state management is depicted wherein the end-to-end state (410) (E2E-BState (410)) is managed internal to the blockchain system (also referred to as the blockchain platform (406), and the incremental state transitions (Inc-BState (408)) are managed external to the blockchain platform (406) at a Blockchain E2E Application Workflow Manager (402) associated with a vLDT/blockchain application (404). The E2E-BState (410) is determined and stored internal to the vDLT/Blockchain platform (406) as a trusted record of changes to the E2E-Bstate (410).

In an exemplary embodiment, some variations are possible where the E2E-BState is recorded external to the blockchain platform as well, for easy access to the state, however for trusted access to the E2E-BState, the vDLT/Blockchain platform will have to be queried. The values associated with the Inc-BStateTrans (408) information can be recorded external to the Blockchain platform (406). However, alternatively the Inc-BStateTrans information can be optionally recorded as part of the transaction record in the vDLT/Blockchain ledger (412).

In FIG. 4B, in an aspect, an ExtExt variation of state management is depicted. In this case, both E2E-BState (410) and Inc-BStateTrans (408) are recorded external to the blockchain platform (406) (or simply referred to as platform (406) hereinafter). In the ExtExt variation of state management the Inc-BStateTrans (408) values are recorded external to the platform (406). The determination of Inc-BStateTrans values can be done on the vDLT/Blockchain platform, and the values can be returned to the calling vDLT/Blockhain application (402). The Inc-BStateTrans information can be included as part of the transaction information recorded on the vDLT/Blockchain ledger (412) but there is no explicit state database for storing Inc-BStateTrans in the vDLT/Blockchain platform. If the E2E-BState is managed external to the platform, then the vDLT/blockchain platform can perform “stateless” execution relative to the E2E-BState. This means that vDLT/Blockchain platform itself does not alter E2E-BState. The current value of the E2E-BState can be submitted to a vDLT/Blockchain platform as input when a blockchain transaction is submitted to the blockchain platform for processing. This avoids the need to check for read-set/write-set conflicts with regard to the E2E-BState which is an expensive serial processing task in other blockchain platforms such as Hyperledger Fabric. However, this does put the burden on the external systems that interact with the vDLT/Blockchain platform to manage the E2E-BState state external to the blockchain platform.

In many use-cases this is a natural thing to do, such as processing the debit of a payer account or processing the credit to a payee account, that can be performed external to the blockchain platform.

In an exemplary embodiment, the E2E-BState state management may be enabled in a common database repository that is managed external to the blockchain platform

For example, Elastic search can be used with optimistic concurrency control with increasing version numbers to ensure that only one transaction modifies a specific version of a document. Alternate database or storage systems can also be used to realize this external database.

In an exemplary embodiment, usage of a microservices-based platform allows for scalable processing of different smart contracts or microservices on the platform. It also enables the stateless processing with respect to E2E-BState on the platform.

In a way of example and not as a limitation, in financial transactions involving money transfers, the overall transaction can include multiple steps. The E2E-BState represents the overall state of progress of the financial transaction (such as money debited from sender's bank account, or money transferred from sending paying bank to receiving bank, or money credited to the receiver's account, and the like). For financial transactions, if an E2E-Bstate Variable (EBV) represents a bank account, then it is desirable to manage this external to the platform (if money transfers involve multiple banks, it is desirable not to share the overall bank balance in the respective bank accounts on a common vDLT/Blockchain platform). The Inc-BState state represents the state transition for each step (such as a completion of a debit, a transfer from one bank to another, a credit at the receiving bank, etc.). The transaction information in the ledger can include the state transition information, along with additional information such as the stakeholders involved in each step (paying user and corresponding bank), the nature of the transaction (a debit or a credit). For financial transactions, an Inc-BState Variable (IBV) that relates to incremental financial transfers between bank accounts could be maintained either internal or external to the blockchain platform as desired by a use-case.

In another exemplary implementation, in a Distributed State Management variation of the ExtInt or ExtExt options, the E2E-BState Information can be maintained in a distributed manner across different nodes that access the vDLT/Blockchain platform. For example, if a submitter of a transaction maintains the E2E-BState of the transaction, where there can be multiple nodes that can submit transactions into the blockchain system. In this case, the E2E-BState is available in a distributed manner.

In an exemplary implementation, for fault tolerance, the E2E-BState can also be replicated across a small subset of nodes in the system. Let there be N nodes in the system, and the E2E-BState is stored with a replication factor of r. If there are M transactions in the system with each submitter node equally likely to be a submitter of a transaction, then the number of transactions submitted by a node is given by M/N on average. With a replication factor of r in the system, the number of E2E-BState states stored per node is given by rM/N.

In FIG. 4C, in an aspect, an IntInt variation of state management is depicted. In this case, both the E2E-BState (410) and Inc-BStateTrans (408) are recorded internal to the platform. All queries to such state information has to go through the blockchain platform. To optimize performance, specialized microservices can be designed such that such read requests are mapped to different vCPUs to access such state without impacting execution of other tasks on the vDLT/Blockchain platform. A copy of the E2E-BState could be maintained external to the vDLT/Blockchain platform. Read-set and Write-set state checking would have to be done to avoid concurrent updates to state by different concurrent transactions that can access the same state—this can impact performance—in this regard it is more desirable to utilize the ExtInt or ExtExt state management approaches

In FIG. 4D, in an aspect, an ExtInt variation of state management is depicted. In an aspect, as illustrated, the End2End(E2E)-BState (410) may be managed external to the blockchain platform (406). The E2E-BTState can be used as an input, but it can always be modified external to the Blockchain platform (406) at a Blockchain E2E Application Workflow Manager (402) associated with a vLDT/blockchain application (404) and is implemented using a database (412) external to the Blockchain platform (406). The Inc-BState (408) may be managed internal to the blockchain platform (406). The Inc-BState (408) may be recorded within the blockchain platform (406) when the state transition is processed with the information about the input data along with the current E2E-Bstate.

In an exemplary embodiment, the Inc-BState can be designed as “CreateAlways” so there is no “state” conflict across blockchain transactions that are processed on the platform. The E2E-BState (410) may be managed external to the blockchain platform. Alternatively, the vDLT/Blockchain Platform does not alter E2E-BState. The current value of the E2E-BState can be provided as input by an external blockchain application to process a state transition, along with additional inputs for transaction processing. The vDLT/Blockchain can take appropriate actions internally based on value of E2E-BState, and can determine an action for the transaction that is recorded in the vDLT/blockchain ledger. A corresponding output may be returned by the vDLT/Blockchain platform to the external blockchain application which may modify E2E-BState based on the outcome of such processing.

The Blockchain E2E Application Workflow manager (402) may analyse the predefined state transition graph for the blockchain application, submitting incremental requests to vDTL/Blockchain platform to enable state transitions. The Inc-BStateTrans is managed internal to the platform and can be stored individually for each transaction in a separate internal state database or a log file. The Inc-BStateTrans can also be appended to the transaction details when the transaction outcome is recorded in the vDLT/Blockchain Ledger (412). The determined value of Inc-BStateTrans can also be returned back to the external blockchain application.

In an exemplary embodiment, the Inc-BStateTrans can be designed as “CreateAlways” so there is no state conflict across blockchain transactions which may help to determine the progress of internal blockchain processing tasks for a state transition such as a successful execution of microservices or successful processing of endorsement requests. If a transaction is resubmitted to the platform, it has to go through the different stages of blockchain processing once again for the new version of the transaction that is submitted and Inc-BStateTrans changes are computed for the new version of the transaction that was submitted. This provides safety of execution—for example an endorser of the transaction is required to endorse the new transaction contents and any previous endorsement for a previous version of the transaction can be ignored if desired.

In an exemplary implementation, in a utility Demand Response (D/R) use-case, different homes or enterprises or other entities respond to a request from the utility company to reduce their energy consumption, when the demand increases significantly. Smart meters at the respective locations can take actions such as turning off appliances that are not required at that time or to increase the temperature setting in a thermostat, and the like. These incremental actions on the incremental state changes (Inc-BState) at each home or enterprise or other entities can be recorded internally on a blockchain as they are performed. The action taken by the participating entities can be recorded so that future rewards if any can be given based on the participatory actions. Based on the incremental state changes, an external application computes the overall change to the current load on the network (E2E-BState) which is managed and utilized external to the blockchain network

In another exemplary implementation, periodically such an E2E-BState variable related to the current load in the utility network can be monitored in the utility network, and such a value can be submitted to the blockchain platform to execute a smart contract that can determine whether a demand-response action needs to be taken. In addition, depending on the current change in the E2E-BState after a response to the D/R request is obtained, a smart contract can determine whether additional load shedding is required by participating entities in the network. This can be utilized to trigger further action if needed. Based on user behavior, incremental credits can be given to users as tokens in a blockchain platform. These can be recorded as Inc-BState variables in the platform. Based on the incremental tokens granted, and overall token balance(E2E-BState) can be maintained external to the platform. As tokens are utilized, an incremental debit can be performed with respect to the global value, and any redemption action related to the tokens can be stored as an Inc-BState value on the platform. Smart contracts can be utilized to execute the credits and redemption processes on the blockchain platform.

In yet another exemplary embodiment, a plurality of IoT sensor measurements can be continuously measured such as vital signs associated the status of a window/door sensor or a motion sensor in a home, or the status of a wearable panic device associated with a mobile user. Any changes in state (or changes that exceed a threshold) associated with these sensor measurements can be recorded as Inc-BState variables in the platform. A smart contract can be executed to trigger an action based on the degree of change associated with the Inc-Bstate variables. Based on the changes to the Inc-BState Variables, an overall external E2E-State for the security of the home, or the security associated with a mobile user can be determined by an external application in the system.

In an exemplary embodiment, in a Hybrid Variation case, the E2E-BState may be recorded external to the platform. The Inc-BStateTrans values may also recorded external to the platform. The determination of some or all of the Inc-BStateTrans values can be done on the platform. In addition, additional Inc-BStateTrans variables can be determined external to the blockchain platform to then determine an overall E2E-BState. Such a setup can be useful if the E2E-BState has some dependencies that are processed external to the vDLT/Blockchain platform. It is desirable however, if such external dependencies are not managed external to the platform.

In a preferred embodiment, information may be submitted related to such potential external dependencies to the vDLT/Blockchain platform, so that all Inc-BStateTrans changes may be recorded on the vDLT/Blockchain Ledger, and recorded in an Inc-BStateTrans database that is managed either internal to the vDLT/blockchain platform or external to the vDLT/blockchain platform. However, if the use-case demands it, then such a hybrid variation can be utilized.

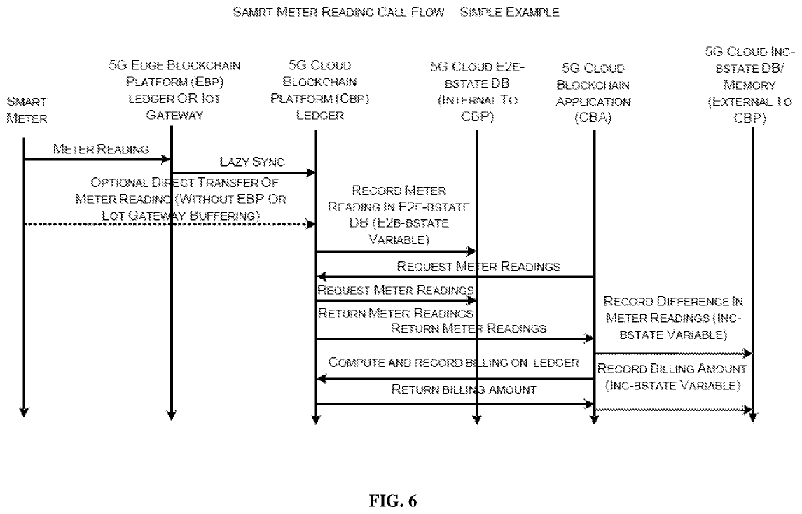

FIG. 5 illustrates an exemplary block diagram (400) of the functional blocks of a Hierarchical Internal Internal (IntInt) State Management, in accordance with an embodiment of the present disclosure. The end-to-end state (410) (E2E-BState (410)) is managed internal to the blockchain platform (406). The E2E-BState (410) is determined and stored internal to the vDLT/Blockchain platform (406) as a trusted record of changes to the E2E-Bstate (410). The incremental state transitions (Inc-BState (408)) are managed external to the blockchain platform (406) at plurality of local supply chain blockchain platforms (502, 504) and recorded as part of the transaction record in a plurality of local vDLT/Blockchain ledger (506, 508).

In an exemplary embodiment, some variations are possible where the E2E-BState is recorded external to the blockchain platform as well, for easy access to the state, however for trusted access to the E2E-BState, the vDLT/Blockchain platform will have to be queried. The values associated with the Inc-BStateTrans (408) information can be recorded external to the Blockchain platform (406). However, alternatively the Inc-BStateTrans information can be optionally recorded as part of the transaction record in the vDLT/Blockchain ledger (412).

In an exemplary embodiment, in a Hierarchical IntInt state management may be used for InterOperator Roaming where a plurality of first users from a network of Operator1 could be roaming in Operator2's network. Similarly, a plurality of second users from the network of Operator2 could be roaming in Operator1's network. The Inc-BState (408) Variables associated with time spent or the data used or calls made (CDRs) by each user in the other operator's network can be recorded based on activity in each network. The E2E-BState (410) Variables associated with the aggregated cost owed by each operator to the other operator can be determined at a common E2E inter-operator blockchain platform. The difference in the amount owed can be determined as a settlement amount in the common E2E inter-operator ledger (412).

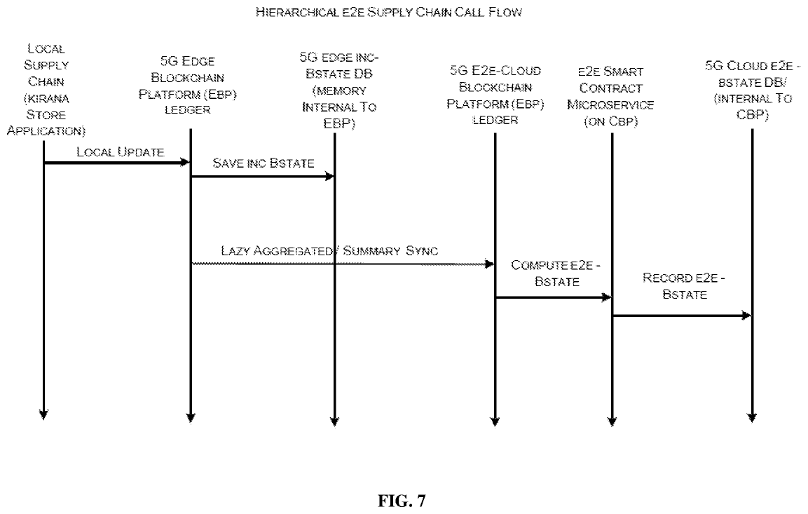

FIG. 6 illustrates an exemplary representation of an example of IntInt state management, in accordance with an embodiment of the present disclosure. Smart meter readings are read periodically, for example, once every 15 minutes. The readings are absolute valued in nature. Thus, the state of the reading corresponds to E2E-BState. This can be recorded on a blockchain ledger at the 5G Edge utility data centerBlockchain Platform (EBP), and synchronized lazily with a ledger in a 5G utility Cloud data centerBlockchain Platform (CBP). The EBP is optional so that the meter reading can be directly transferred to the CBP in the absence of the EBP. If the EBP is available, then an aggregate reading can be transferred to the CBP. An IoT gateway with storage can also serve the function of the EBP, so submit an aggregate reading to the CBP.

The E2E-BState Variable (EBV) for each meter reading is created every time there is a new reading and stored in the E2E-BState DB internal to the platform.

When a billing needs to happen, the difference in the E2E-BState values on two different dates is the Inc-BState value to determine the kWHs of energy utilization. This difference in billing is an Inc-BState Variable (IBV) that is computed and stored external to the blockchain platform in an Inc-BStateDB/Memory. It is submitted to the blockchain platform to execute a smart contract can be utilized to determine and record the billing on the blockchain ledger in the CBP based on a conversion factor between kWHs and the currency (INRs/Dollars/etc.). The determined billing is also an Inc-BState variable (IBV) that is recorded on CBP.

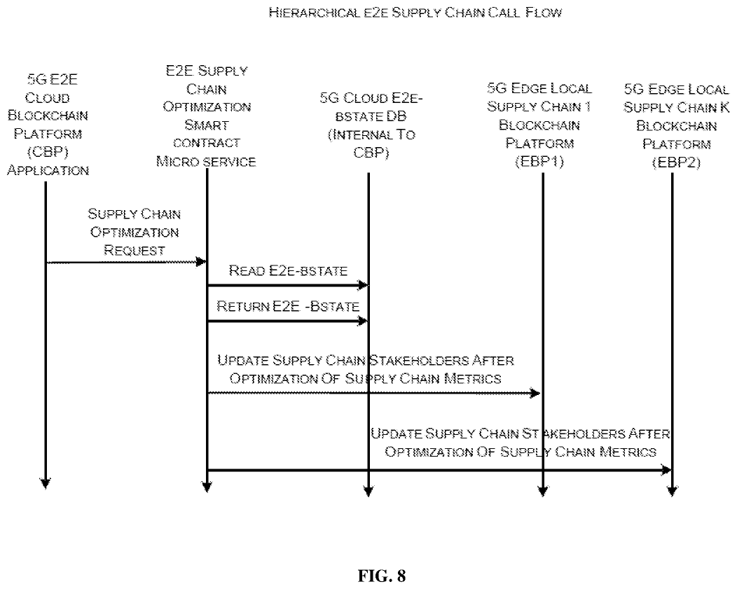

FIGS. 7-8 illustrate exemplary representations of Hierarchical State Management, in accordance with an embodiment of the present disclosure.

As illustrated, an end-to-end supply chain could contain multiple participating entities that do not necessarily have to all interact with each other. For example, in a retail supply chain delivery involving Kirana stores, the local specifics about the local delivery of goods could be managed in a local blockchain platform ledger at a 5G/6G Edge Data Center. Whenever useful a summary update (such as an update regarding a successful delivery and the time of delivery) from the local supply chain vDLT/blockchain platform can be provided to the E2E Supply Chain vDLT/blockchain platform ledger. Thus Inc-BState Variables regarding local updates are maintained in the respective local supply chain vDLT/blockchain platforms in the supply chain, and the overall end-to-end state update using E2E-BState Variables can be maintained in the E2E Supply Chain vDLT/blockchain platform.

The E2E Supply Chain optimization can be performed based on updated values of the E2E-BState Variables to determine future predicted values of goods delivery at the remaining stages of the supply chain for example In Supply Chain transactions including goods transfer from a source A to the destination E, the overall transaction can include multiple steps (such as A→B, B→C, C→D, D→E, where B, C, and D are intermediate nodes in the supply chain). The E2E-BState represents the overall state of progress of the supply chain transaction (such as the current location of a good being transferred in the supply chain but not limited to it).

In an ExtExt or ExtInt system, the E2E-BState is maintained external to the vDLT/Blockchain platform. In an IntInt or IntExt system, the E2E-BState is maintained internal to the vDLT/Blockchain platform.

In a supply chain system, it is desirable to maintain the E2E-BState information about goods internal to the blockchain platform so that all stakeholders have access to this information.

The Inc-BState state represents the state transition for each step (such as the completion of a particular leg of the goods transfer in the supply chain). For example this can represent the receiving of goods at C in the supply chain. The transaction information in the ledger can include the state transition information, along with additional information such as the stakeholders involved in that state transition such as the shipper and the receiver for the leg B→C, the time of receiving the goods at C)

In an ExtExt or IntExt system, the Inc-BState state is maintained external to the vDLT/Blockchain platform. In an ExtInt or IntInt system, the Inc-BState state is maintained internal to the vDLT/Blockchain platform.

In a supply chain system, it is desirable to maintain the Inc-BState information about goods internal to the blockchain platform so that all stakeholders have access to this information.

For example, oil pipelines need to check for oil leaks in the pipeline which may be either intentional or accidental faults in the pipeline. Bernoulli's principle is utilized to detect such leaks to detect a change in the flow rate Q=Av (area×velocity) that leads to a corresponding change in pressure in the pipeline

p₁+v₁²/2g+ρh₁=p₂+v₂²/2g+ρh₂=constant

In addition, the equation of continuity is given by A₁v₁=A₂v₂=Q (flow rate). Here pᵢ, vᵢ, Aᵢ, hᵢ, correspond to the pressure, velocity, area, and height respectively at different locations i along the pipeline. For example, at a fixed height along the oil pipeline, p+v²/2g=constant, so that ∂p is proportional to v ∂v or effectively proportional to Q ∂Q. A leak can cause a change in the flow rate which can effect a change in the pressure, such the drop in pressure can be correlated to a leak.

However false alarms are possible due to transient flow rate changes or density changes or pressure changes, so that the it is important to perform statistical filtering on the data to detect a leak. Alternative techniques based on the difference in the volume flow across different sections of the pipeline over a given time period can also be used to perform leak detection. As IoT data is measured in the pipeline related to such metrics, such information can be recorded (“create-always” Inc-BState values), and smart contracts can be executed based on observed flow rate changes or pressure changes or volume imbalances to detect whether there is a leak (E2E-BState value) based on the data processing. The detected leak can also be recorded as a “create-always E2E-BState value.

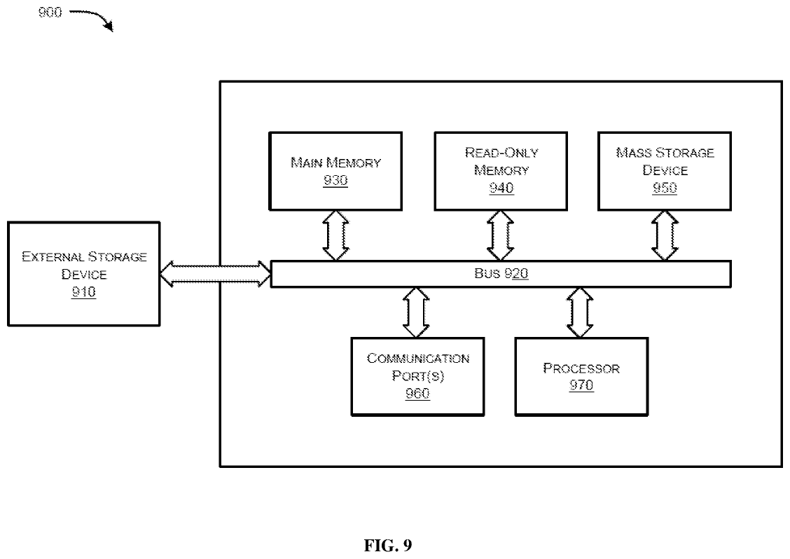

FIG. 9 illustrates an exemplary computer system in which or with which embodiments of the present invention can be utilized in accordance with embodiments of the present disclosure. As shown in FIG. 9, computer system (900) can include an external storage device (910), a bus (920), a main memory (930), a read only memory (940), a mass storage device (970), communication port (960), and a processor (970). A person skilled in the art will appreciate that the computer system may include more than one processor and communication ports. Examples of processor (970) include, but are not limited to, an Intel® Itanium® or Itanium 2 processor(s), or AMD® Opteron® or Athlon MP® processor(s), Motorola® lines of processors, FortiSOC™ system on chip processors or other future processors. Processor (970) may include various modules associated with embodiments of the present invention. Communication port (960 can be any of an RS-232 port for use with a modem-based dialup connection, a 10/100 Ethernet port, a Gigabit or 9 Gigabit port using copper or fiber, a serial port, a parallel port, or other existing or future ports. Communication port (960 may be chosen depending on a network, such a Local Area Network (LAN), Wide Area Network (WAN), or any network to which computer system connects. Memory 930 can be Random Access Memory (RAM), or any other dynamic storage device commonly known in the art. Read-only memory (940) can be any static storage device(s) e.g., but not limited to, a Programmable Read Only Memory (PROM) chips for storing static information e.g., start-up or BIOS instructions for processor (970). Mass storage (950) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 792 family) or Hitachi (e.g., the Hitachi Deskstar 7K900), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus (920) communicatively couple processor(s) (970) with the other memory, storage and communication blocks. Bus (920) can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor (970) to software system.

Optionally, operator and administrative interfaces, e.g., a display, keyboard, joystick and a cursor control device, may also be coupled to bus (920) to support direct operator interaction with a computer system. Other operator and administrative interfaces can be provided through network connections connected through communication port (960). The external storage device (99) can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

The present disclosure provides a method and system for support for configurable internal versus external state management relative to a vDLT/Blockchain platform with support for determining both incremental states and end-2-end states utilizing configurable internal versus external smart contract microservices to process information. Depending on the needs of a use-case, the state processing can be configured appropriately as ExtInt, ExtExt, IntExt, or IntInt with respect to the end-to-end and incremental state variables, with flexibility in the system to configure state variables as needed in the system. Different vDLT/Blockchain use-cases have been explored as well so that specific claims associated with each of the use-cases can be processed.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosures provide a system and a method that facilitates support for configurable state management.

The present disclosures provide a system and a method that facilitates flexibility in operation.

The present disclosures provide a system and a method that enables different vDLT/Blockchain use-cases to be processed.

We claim:

1. A state management system (110) for facilitating configurability in blockchain based transactions, the system comprising:
one or more processors coupled to one or more computing devices (104) in a network (106), wherein the one or more processors (202) are further coupled with a memory (204), wherein said memory stores instructions which when executed by the one or more processors (202) causes the system (110) to:
receive a set of data packets from a computing device (104), the set of data packets comprising one or more transactions in any or a combination of one or more incremental blockchain transitions and one or more end to end blockchain transaction from an initial end to end blockchain state (E2E-BState) to an end end-to-end blockchain state (E2E-BState), wherein the one or more transactions pertain to one or more state variables;
extract a first set of attributes from the received set of data packets, the first set of attributes corresponding to one or more paths in a state transition graph starting from the initial end to end blockchain state to the end end-to-end blockchain state;
trace, by a machine learning (ML) engine operatively coupled to the one or more processors, a predefined path based on the extracted first set of attributes, such that the predefined path is secure and any or a combination of the incremental blockchain transitions and the end-to-end blockchain state transitions are configurable;
capture and store, one or more changes to the state variables obtained after tracing each state transition in the any or a combination of incremental transitions and end to end transaction from the initial E2E-BState to the end E2E-BState in a database; and,
determine an outcome associated with the one or more changes to the state variables for each state transition in the any or a combination of incremental transitions and end to end transaction from the initial E2E-BState to the end E2E-BState.

2. The system (110) as claimed in claim 1, wherein the state variables pertain to one or more parameters of a transaction.

3. The system (110) as claimed in claim 1, wherein an information about a state is a combination of both a current value of each state variable, and an incremental state transition if each state variable underwent a transition during a state transition.

4. The system (110) as claimed in claim 2, wherein a plurality of options is provided to store the information about the state that is either internal or external to the system, the plurality of options including variations comprising an External-Internal (ExtInt) variation, an Internal-internal (IntInt) variation, an External-external (ExtExt) variation, and an Internal-External (IntExt) variation for the end-to-end state and the incremental state transition management.

5. The system (110) as claimed in claim 3, wherein in the ExtIntvariation, the one or more processors manage the end-to-end state external to the system (110), and wherein the incremental state transitions are managed internal to the system (110).

6. The system (110) as claimed in claim 3, wherein in the IntInt variation, the one or more processors manage both the end-to-end state and the incremental state transitions internal to the system (110).

7. The system (110) as claimed in claim 3, wherein in the ExtExt variation, the one or more processors manage both the end-to-end state and the incremental state transitions external to the system (110).

8. The system (110) as claimed in claim 3, wherein in the IntExt variation, the one or more processors manage the end-to-end state internal to system (110), and wherein the incremental state transitions are managed external to the system (110).

9. The system (110) as claimed in claim 8, wherein the one more processor further causes the system to:
manage, the one or more state variables external to the system (110) in a stateless manner;
centrally distribute, the one or more state variables are state variables in the system (110);
distribute equally the one or more state variables among the one or more computing devices associated with the system (110);
store the one or state variables in a single computing device;
manage, the one or more state variables in one or more computing devices (peers).

10. The system as claimed in claim 1, wherein the one or more processor further causes the system (110) to manage, the variations based on a level of pre-determined trust in the one or more computing devices associated with the system (110).

11. The system (110) as claimed in claim 11, wherein the one more processor further causes the system to:
transition a state variable from a centralized management module to a concurrently distributed management module associated with the one or more processors and vice versa;
manage the state transfers ownership of a state variable to another computing device;
transfer the ownership of a state variable up and down a hierarchical chain of computing devices.

12. The system (110) as claimed in claim 1, wherein the one or more processor causes to orchestrate an end-to-end processing of one or more incremental tasks associated with the one or more transactions.

13. A method for facilitating configurability in blockchain based transactions, the method comprising:
receiving, by one or more processors, a set of data packets from a first computing device (104-1), the set of data packets comprising one or more transactions in any or a combination of one or more incremental blockchain transitions and one or more end to end blockchain transaction from an initial end to end blockchain state (E2E-BState) to an end end-to-end blockchain state (E2E-BState), wherein the one or more transactions pertain to one or more state variables, wherein the one or more processors are coupled to one or more computing devices (104) in a network (106), wherein the one or more processors (202) are further coupled with a memory (204);
extracting, by the one or more processors, a first set of attributes from the set of data packets received, the first set of attributes correspond to one or more paths in a state transition graph starting from the initial end to end blockchain state to the end end-to-end blockchain state;
tracing, by a machine learning (ML) engine operatively coupled to the one or more processors, a predefined path based on the first set of attributes extracted, such that the predefined path is secure and any or a combination of the incremental blockchain transitions and the end-to-end blockchain state transitions are configurable;
capturing, by the one or more processors, one or more changes to the state variables obtained after tracing each state transition in the any or a combination of incremental transitions and end to end transaction from the initial E2E-BState to the end E2E-BState in a database;
determining, by the one or more processors, an outcome associated with the one or more changes to the state variables for each state transition in the any or a combination of incremental transitions and end to end transaction from the initial E2E-BState to the end E2E-BState.

14. The method as claimed in claim 13, wherein the state variables pertain to one or more parameters of a transaction.

15. The method as claimed in claim 13, wherein an information about a state can be a combination of both a current value of each state variable, and an incremental state transition if each state variable underwent a transition during a state transition.

16. The method as claimed in claim 13, wherein a plurality of options is provided to store the information about the state that is either internal or external to the system, the plurality of options including a plurality of variations comprising an External-Internal (ExtInt) variation, an Internal-internal (IntInt) variation, an External-external (ExtExt) variation, and an Internal-External (IntExt) variation for the end-to-end state and the incremental state transition management.

17. The method as claimed in claim 16, wherein in the ExtIntvariation, the one or more processors manage the end-to-end state external to the system (110), and wherein the incremental state transitions are managed internal to the system (110), wherein in the IntInt variation, the one or more processors manage both the end-2-end state and the incremental state transitions internal to the system (110).

18. The method as claimed in claim 16, wherein in the ExtExt variation, the one or more processors manage both the end-to-end state and the incremental state transitions external to the system (110) and, wherein in the IntExt variation, the one or more processors manage the end-to-end state internal to system (110), and wherein in the incremental state transitions are managed external to the system (110).

19. The method as claimed in claim 13, wherein the method further comprises the step of managing, by the one or more processors, the one or more state variables external to the system (110) in a stateless manner;
distributing centrally, by the one or more processors, the one or more state variables are state variables in the system (110);
distributing equally, by the one or more processors, the one or more state variables among the one or more computing devices associated with the system (110);
storing, by the one or more processors, the one or state variables in a single computing device; and,
managing, by the one or more processors, the one or more state variables in one or more computing devices (peers).

20. The method as claimed in claim 13, wherein the method further comprises the step of:
transitioning, by the one or more processors, a state variable from a centralized management module to a concurrently distributed management module associated with the one or more processors and vice versa;
managing, by the on e or more processors, the state transfers ownership of a state variable to another computing device; and,
transferring, by the one or more processors, the ownership of a state variable up and down a hierarchical chain of computing devices.
